(19) United States
(12) Patent Application Publication
(10) Pub. No.: US 2007/0162295 A1
(43) Pub. Date: Jul. 12, 2007

(54) HEALTHCARE MANAGEMENT SYSTEM AND METHOD

(76) Inventors: Adil Jamal Akhtar, Bloomfield Hills, MI (US); Jayakumar Ravindran, Novi, MI (US); Rupesh Srivastava, West Bloomfield, MI (US)

Correspondence Address: FALKOWSKI PLLC, P.O. BOX 650, NOVI, MI, 48376-0650, US

(21) Appl. No.: 11/466,438

(22) Filed: Aug. 22, 2006

Related U.S. Application Data
(60) Provisional application No. 60/595,986, filed on Aug. 22, 2005.

(51) Int. Cl. G06Q 99/00

(52) U.S. Cl. 705/1

(57) ABSTRACT

A system and method for managing healthcare in which payers, providers, pharmacists, and/or patients can interact with appropriate aspects of a particular treatment or surveillance plan. Treatment and/or surveillance plans can be designed, created, selected, implemented, tracked, evaluated, modified, improved, expanded, and/or otherwise managed. Outcomes data can be used to update efficacy data, which in turn can influence future treatment and/or surveillance plans. A wide variety of different types of data can influence the functionality of the system. A wide range of technical architectures can be used to achieve the functionality of the system.

### RELATED APPLICATIONS

This utility application claims priority from the provisional patent application titled “TREATMENT PLAN SYSTEM AND METHOD” (60/595,986) that was filed on Aug. 22, 2005 and is hereby incorporated by reference in its entirety.

### BACKGROUND OF INVENTION

The invention relates generally to systems and methods for managing health care (collectively the “system”). The system can be used to design, create, select, implement, track, evaluate, modify, improve, expand, and/or otherwise manage plans, such as treatment plans and/or surveillance plans.

Due to advances in medical treatments, an increasing number of medical conditions previously considered terminal can now be subjected to meaningful medical treatments. Cancer and other serious diseases and medical conditions are increasingly being classified as chronic conditions instead of terminal or acute conditions. On the other end of the continuum, less severe conditions such as obesity, inadequate sexual performance, anxiety, and other conditions are also being dealt with using a wide variety of different treatments. The number of potential treatments and treatable conditions are increasing, increasing the options available to patients and providers.

The ability to provide a greater number of potential treatments to patients suffering from undesirable conditions is good news for patients, but the number of viable treatments raises ever increasing concerns related to costs. For example, the increase in survival rates for cancer patients raises several challenges to the health care system. After heart disease, cancer is the second most costly and lethal disease in the United States. Annual treatment costs for cancer now exceed $170 billion. Approximately 15% of all medical expenses for health plans relate to cancer treatments. Of the direct medical costs for cancer treatment, 90% of those costs are associated with the treatment for cancer of the breast, colorectal, lunch, prostate, or bladder.

Despite the often dramatic costs of treating cancer and other conditions, no incentive exists for physicians and other health care providers (collectively “providers”) to rationalize the costs associated with various treatments. To the contrary, more expensive drugs and protocols often generate higher fees for providers, and liability concerns can further encourage excessively expensive “defensive” medical practices that do little or nothing to assist patients. Furthermore, some physicians may believe that mere cognizance of cost-effectiveness compromises care.

Further impeding attempts to better manage healthcare is the lack of effective mechanisms to evaluate what constitutes cost-effective care in a comprehensive and detailed manner. Fragmented information channels can negatively impact the both pre-treatment decisions and post-treatment efficacy assessments. Difficulties in understanding or predicting the total cost of treatment are symptomatic of fragmented processes that often involve poor communication among providers, pharmacists, patients, and health plan payers. Such fragmentation impedes the ability of patients, pharmacists, providers, and payers to consider the overall treatment of a patient in an integrated and timely manner. Either knowingly or unknowingly, prudent regimen guidelines can be deviated from or ignored. Under dosing or over dosing can result in poor responses or an increase in toxicity. Fragmentation can also result in various failures to follow-up on treatment responses, and impede efforts to capture and analyze outcomes data for future patients and future treatments.

### SUMMARY OF INVENTION

The invention is a system and method for designing, creating, selecting, implementing, tracking, evaluating, modifying, improving, expanding, and/or otherwise managing treatment plans and/or surveillance plans (collectively the “system”). By enhancing the exchange of information between patients, payers, and/or providers, the cost effectiveness and/or quality of healthcare can be improved.

The system can be more fully understood upon reading the following detailed description in conjunction with the accompanying drawings.

### BRIEF DESCRIPTION OF THE DRAWINGS

FIG. 1 is a block diagram illustrating an example of how the system can be used to accommodate interactions between providers, patients, payers, and/or pharmacists through interactions with a treatment plan that itself interacts with interaction data, regimen data, patient data, and/or efficacy data.

FIG. 2 is a process flow diagram illustrating some of the different processing elements that can be invoked as different entities interact with each other and the treatment plans and/or surveillance plans processed by the system.

FIG. 3 is a block diagram illustrating an example of some of the different devices and interfaces that can be used by the system and some of the different types of data that can influence the processing of the system.

FIG. 4 is an input-output diagram illustrating an example of some of the different factors that can influence a treatment plan managed by the system.

FIG. 5 is a block diagram illustrating an example of a subsystem-level view of the system in which a management application is the interface for interactions between a patient subsystem, a provider subsystem, a payer subsystem, and/or a pharmacy subsystem.

FIG. 6 is a block diagram illustrating an example of a subsystem-level view of the system in which a plan (such as a treatment plan or a surveillance plan) is the interface for interactions between a condition subsystem, a regimen subsystem, an approval subsystem, and/or an order subsystem.

FIG. 7 is a flow chart illustrating an example of how a payer can use the system to influence treatment plans.

FIG. 8 is a flow chart illustrating an example of how a patient can use the system to influence their treatment plan.

FIG. 9 is a flow chart illustrating an example of a how a provider can use the system to create a treatment plan for a patient.

FIG. 10 is a flow chart illustrating an example of a pharmacy using the system to influence a treatment plan.

FIG. 11 is a multi-threaded flow chart illustrating an example of different entities using the system.

### DETAILED DESCRIPTION

I. Overview

The invention is healthcare management system and method (collectively the “system”). Treatment plans and/or surveillance plans can be designed, created, selected, implemented, tracked, evaluated, modified, improved, expanded, and/or otherwise managed.

The system can provide the means to facilitate the exchange of information between appropriate individuals and organizations such as patients, providers, payers, and pharmacies (collectively “entities) in a timely, accurate, proactive, automated and comprehensive manner. Different entities can access the system using the Internet, the World Wide Web, or some other communication network to interact with each other, and useful information such as patient data, efficacy data, regimen data, and interaction data.

The following functions can be supported in wide variety of different embodiments of the system using a variety of different information technology architectures and communication devices:
Integration of practice management systems (PMS) and other forms of regimen information and efficacy data into the design of treatment plans
Proactive filtering of potential treatment plan options in an automated or substantially automated manner based on interaction data, regimen data, patient data, and efficacy data
Save money by selecting cost-effective treatments based on all relevant available information
Iterative communications and exchanges between entities that result in modifications to a treatment plan or surveillance plan before it is completed
Proactive influence over potential treatment plan options by payers, pharmacies, and/or patients and the applicable processing rules defined by the applicable entity
Gathering all relevant and useful information (including patient data, efficacy data, interaction data, regimen data, and payer rules) to the provider at the time that a work-up for a treatment plan is created
Automated pre-approvals of work-ups and treatment plans based on payer defined rules
Electronic submission of work-ups and treatment plans by providers to payers
Creation of electronic treatment plans
Selective sharing/disclosing of electronic treatment plans with all applicable entities
Creation of surveillance plans to monitor the progress of patients under their treatment plants
Automated alerts based on patient parameters during the treatment period
Capture of outcomes data for integration into the efficacy data used to create and monitor future treatment and surveillance plans
Automated feedback and follow-up loops for inter-entity communications, notices, and alerts
Automated processing triggered by various statuses processed by the system
Access to healthcare data throughout the course of treatment by patients and individuals authorized by the patients such as family members
Creation, modification, implementation, and the automated capturing and analysis of data from surveillance plans
Aggregation of surveillance data for long-term outcomes analysis
Direct communication and interaction with specialty pharmacies for therapy and adjunctive pharmaceutical purchasing
Make real-time treatment planning goals and objectives clearly displayed and easily accessible to the appropriate persons, agencies, and organizations
Entry and storage of diagnostic information for future reference by providers and other appropriate entities
Storage of potentially all relevant data that relates to a particular condition or diagnosis for future reference by providers and other appropriate entities
Pre-approvals, certifications, and auto-adjudication of billing claims based on proactive payer rules

By enhancing the exchange of information between patients, payers, and/or providers, the cost effectiveness, quality, reporting, and/or outcomes of treatment plans can be improved. The communication and information sharing can enhance decisions made relating to disease staging, treatment planning, and response evaluation. The system can be used to create more effective treatment plans that can begin at earlier stages in the progression of a disease or medical condition.

Different embodiments of the system can involve different degrees of automation and interaction. By capturing and storing information in a centralized location, efficacy data can be more effectively accessed and updated. Treatment plans can be enhanced by the analysis of efficacy data. By keeping payers in the information “loop” in defining acceptable treatment regimens, costs can be reduced because payers can better leverage their buying power to reduce costs. All of the involved entities can benefit from the development and management of “best practices” guidelines maintained by use of the system. By keeping pharmacies in the information “loop” complications resulting from undesirable drug interactions can be avoided early on, at the point in time that the provider begins preparing the work-up.

“Centers of Excellence” can be defined based on quality, outcomes, reporting, and cost-effectiveness. Over time, payers can change their benefit plans to encourage patients to use designated “Centers of Excellence.” Over time, all entities can modify and improve their knowledge and assessments based on outcomes data and other empirical data.

The system can also improve communications with patients and reduce paperwork for patients as they visit with various providers and undergo various treatments as part of their treatment plan. In some embodiments, patients can even interact directly with the system using a web browser to schedule certain treatment components, enter patient data, etc. The system can be integrated with other “paperless” office applications to maximize the ability of different entities to quickly access information that is appropriate for them to access. Data can be exported to other health care related applications to capture benefits of information integration. For example, pre-approved treatment components can be billed as such.

The system can enhance the implementation of treatment plans because the system can be used by multiple entities to track the performance of a particular treatment plan. In such embodiments, outcome data can easily be captured, stored, and analyzed for use in influencing future treatment plans.

The system can include substantial automated functionality relating to notifications of applicable entities and a wide range of different reports. Commonality of reporting can be established using the system. The system can serve as a data collection framework that is configured to automatically collect data from a wide variety of different sources. Outcome measurements can be collected and analyzed to analyze trends in treatment that relate to individual patients or categories involving multiple patients.

II. Introduction of Entities and Process Elements

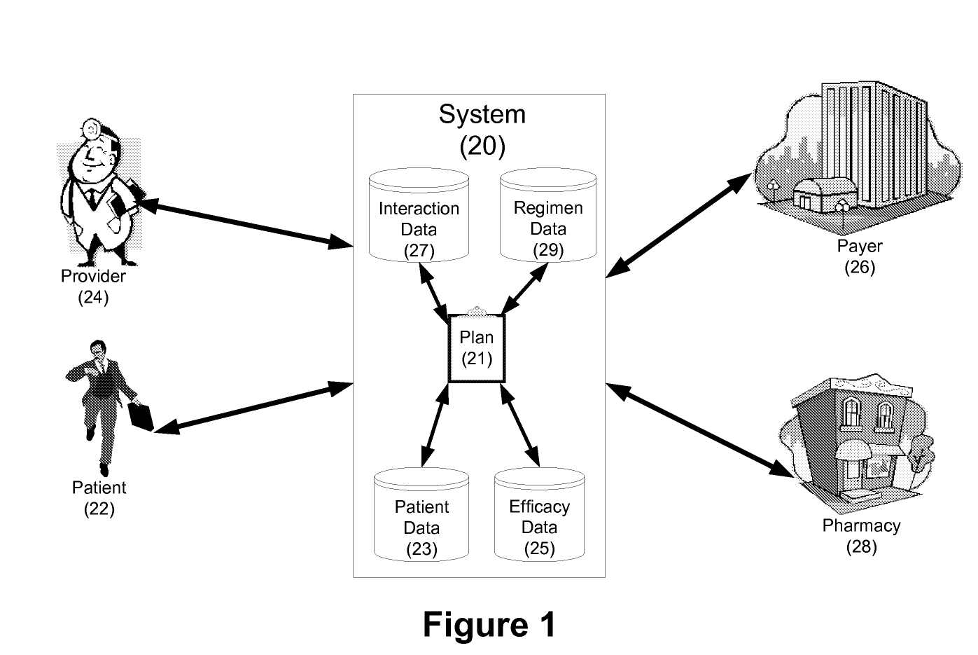

FIG. 1 is a block diagram illustrating an example of how a management system 20 can be used to accommodate interactions between a provider 24, a patient 22, a payer 26, and/or a pharmacy 28 through interactions with a plan 21 (such as a treatment plan or a surveillance plan) that itself interacts with interaction data 27, regimen data 29, patient data 23, and/or efficacy data 25.

Different embodiments of the system 20 can involve different degrees of automation and data sharing. In some embodiments of the system 20, each entity can configure a variety of rules and preferences to automatically effectuate some of the goals and preferences of the particular entity.

A. Entities

A wide variety of different persons and organizations (collectively “entities”) can interact with each other using the system 20. FIG. 1 is merely one example of different entities interacting with each other. As illustrated in FIG. 1, the system 20 can facilitate the flow of information between a patient 22, a provider 24, a payer 26, and a pharmacy 28. The system 20 can selectively give different entities different degrees of access to information stored on the system 20.

1. Patient

A patient 22 is a living organism whose medical treatment is being managed by the system 20. In many embodiments of the system 20, patients 22 are human beings. In other embodiments, patients 22 could also include pets, zoo animals, and a wide variety of other forms of living organisms. The system 20 can improve services to patients 22 by enhancing the flow of information between patients 22, providers 24, payers 26, pharmacies 28, and other third-party service providers such as specialized labs and testing facilities.

An individual treatment plan, surveillance plan, or some other type of plan (collectively a “plan” 30) typically focuses on an individual patient 22. Some treatment plans 30 may relate to more than one patient 22, and the system 20 can be used to manage treatments and surveillance that relate to more than a single patient 22.

In some embodiments, patients 22 can interact directly with the system 20 to schedule appointments, provide historical medical information, renew health coverage, pay for services, receive prescriptions, submit symptom information, view various plans 30, set up automated alerts based on surveillance data, configure various provider rules, and authorize surrogates to interact with the system 20 on behalf of the provider 22.

2. Provider

The treatment of a particular patient 22 can often involve more than one provider 24. A provider 24 is a medical professional who provides services to the patient 22 that relate directly or indirectly to a medical condition 46, such as a disease. Providers 24 can include general practice physicians, specialist physicians, physician assistants, nurses, medical technicians, etc.

Providers 24 can play a pivotal role in the treatment of patients 22. Use of the system 20 does not decrease the importance of providers 24 in treating patients 22 or otherwise limit the value of their experience and expertise. Use of the system 20 can enhance the effectiveness of providers 24 by giving providers 24 access to all relevant parameters before a treatment plan, surveillance plan, or other type of plan 30 is created. A patient's medical history, current medications, health plan coverage, and other information can assist providers 24 in identifying the best plan 30 given a payers 26, patients 22, pharmacies 28, and other third-party service entities greater input into the creation, selection, implementation, evaluation, improvement, and management of treatment plans 30. In particular, payers 26 can have access to a broader range of outcomes data and accordingly, payers 26 can be in a good position to shape treatment plans 30. The system 20 can be configured to allow payers 26 to shape the options that are available to providers 24, and even to require that a payer 26 approve a plan 30 before it is implemented. However, the plan 30 is still prepared by the provider 24.

The system 20 can be used to assist providers 24 in diagnosing a medical condition at an earlier stage. The system 20 can also be used to support a library of pre-approved treatment plans that cover earlier stages of various conditions.

Use of the system 20 by providers 24 also serve to capture and store efficacy data 25 on an ongoing basis so that future treatment plans can benefit from the feedback generated by current treatments.

3. Payer

A payer 26 is an organization responsible for paying for some or all of the treatments provided to patients 22 by providers 24. Payers 26 can include health insurance companies, self-insured employers under ERISA, hospitals, health management organizations (“HMOs”), government health care programs such as Medicare or Medicaid, and any other source of payments for health care services provided to a patient 22.

Payers 26 are typically the best situated entity for negotiating bulk purchase agreements with pharmacies 28, lab service providers, and other third party suppliers. By arming payers 26 with better information on a timely basis, the system 20 can allow payers 26 to define better treatment regimens (e.g. treatment plans) that begin at earlier stages of progression for a condition 46. Payers 26 are well situated to collect outcome and treatment data for large numbers of patients 22 because payers 26 are receiving bills for the various treatment components 48 and are in a position to monitor for outcome data. The participation of payers 26 can allow the system 20 to be very valuable in collecting efficacy data 25 and regimen data 29.

Many of the benefits of the system 20 result from the increased communication and data sharing that can occur between payers 26 and providers 24. By placing payers 26 in the “loop” during the process of designing a treatment plan 30, the ability of the provider 24 to access efficacy data 50 and to make more cost-effective decisions is enhanced. This can also remove barriers down the road with respect to the payment of claims.

Different embodiments of the system 20 can involve different degrees of control and/or influence by the payer 26. For example, the ability of a provider 24 to deviate from pre-approved treatment plans given a specific set of circumstances can vary from embodiment to embodiment. In many embodiments of the system 20, the rules and preferences set by payer 26 influence and shape the options available to providers 24, patients 22, and pharmacists 28.

4. Pharmacy

The fourth entity disclosed in FIG. 1 is a pharmacy 28. Pharmacies 28 are organizations responsible for providing pharmaceuticals to patients 22. Pharmaceuticals are an increasingly important and expensive component of health care. The ability of pharmacies 28 to better access data relevant to the treatment of a patient 22 can avoid undesirable drug interactions as well as enhance the ability of pharmacies 28 to propose alternative pharmaceutical treatments to payers 26 and providers 24 that are potentially more effective and/or more cost effective. Pharmacies 28 can also be an excellent source for surveillance data, as patients 22 request re-fills and otherwise interact with pharmacies 28 during the treatment process.

The system 20 is highly flexible, and can accommodate a wide variety of different relationships between pharmacies 28 and payers 26 as well as pharmacies 28 and providers 24.

Pharmacies 28 are the most common example of a third-party supplier.

5. Other Third-Party Suppliers

In addition to pharmacies 28, other third-party suppliers can be important to the process for managing the treatment of patients 22. For example, various medical tests and treatments may require services from independent laboratories. In some embodiments of the system 20, such entities can interact directly with the system 20. In many respects, pharmacies 28 can be thought of as merely the most common type of third-party supplier.

Due to limitations of space, no other third-party suppliers are shown on FIG. 1. Nonetheless, payers 26 can leverage the information access provided by the system 20 to contain costs and improve services provided by other third-party suppliers.

B. Plan

A plan 21 is a series of activities that occur over time. Two common examples of plans 21 that can be processed by the system are treatment plans and surveillance plans. Treatment plans identify therapeutic actions such as chemotherapy, medications, exercise, rehabilitation, nutritional constraints, etc. intended as treatments to the medical condition of the patient 22. Surveillance plans are plans 21 that monitor the progress of a patient's health over the course of and after the treatment plan is implemented. For example, a surveillance plan could include blood tests, x-rays, cholesterol levels, blood pressure and virtually any other parameter, metric, or test that relates to the treatment of the patient 22.

As illustrated in FIG. 1, the system 20 promotes communications between different entities. As is also illustrated in FIG. 1, a plan 21 (be it a treatment plan 30 or a surveillance plan 31) is a significant nexus for information relating to the treatment of a patient 22. In many respects, different entities can interact with each other by interacting with the plan 21. As illustrated in FIG. 1, the plan 21 processed by the system 20 can be thought of a nexus of different types of information that can influence the plan 21 for the benefit of the patient 22.

C. Relevant Data for an Effective Plan

Just as the system 20 can serve as a clearinghouse for communications and interactions between entities, the plan 21 can serve as a clearinghouse or conduit for data relevant to the treatment and/or surveillance of patients 22. FIG. 1 discloses examples of different types of information that are typically relevant to a wide variety of different plans 21. The different types of data identified below can be stored and accessed using a wide variety of different data storage technologies and architectures.

In some embodiments of the system 20, the linkage between different types and sources of information and the applicable plan 21 can be active on a continuous or nearly continuous basis, allowing for a change in even a single input parameter to result in a change to the applicable plan 21, an alert, a communication, or some other automated action by the system 20.

1. Patient Data

Patient data 23 can include any information relating to a patient 23. Patient data 23 can include: (a) medical information such as x-rays of tumors, test results, blood pressure, and any other information relating to one or more conditions being suffered by the patient 22; (b) business information relating to insurance coverage such as insurance policies, billing address, deductibles, contact information, premiums, payment mechanisms, credit cards, bank accounts, authorized surrogate decision makers, etc; (c) historical information relating to past conditions, treatments, prescriptions, family medical history, etc.; (d) surveillance data relating to information obtained in monitoring the progress of a treatment plan with respect to the patient 22 and his or her condition; and (e) any other attribute relating in any way to the patient 22.

The system 20 can be used to access, create, update, delete, and store patient data 23. The system 20 can be configured to trigger certain alerts and/or processing changes based on changes to patient data 23. Thus, a change in patient data 23 could automatically trigger a re-examination of a treatment plan by the provider 24 in certain circumstances.

2. Efficacy Data

Efficacy data 25 is information that relates to the effectiveness of a particular treatment activity and/or component with respect to a particular condition. Efficacy data 25 is most useful when it delineates between different material parameters. For example, the effectiveness of a particular plan 21 may depend on the weight, sex, general health, age, family history, or any other patient data 23. The system 20 can both utilize efficacy data 25 as an input as well as generate efficacy data 25 as an output for future use.

Efficacy data 25 can be used by the system 20 to identify desirable plans 21 and even influence options for which providers 24 can choose from. Changes in efficacy data 25 can be used by the system 20 to trigger alerts, communications, and other forms of automated processing.

The system 20 can be used to access, create, update, delete, and store efficacy data 25. The system 20 can be configured to trigger certain alerts and/or processing changes based on changes to efficacy data 25. Thus, a change in efficacy data 25 could automatically trigger a re-examination of a treatment plan by the provider 24 in certain circumstances. For example, efficacy data 25 could indicate that a certain sequence of activities or combination of parameters may render a certain treatment ineffective or even undesirable.

3. Interaction Data

Interaction data 27 is information relating to how one treatment component and/or activity can involve undesirable side-effects when coupled with another treatment component and/or activity. A common example of an undesirable interaction is a medications that cause side effects when couple with certain other medications,

The system 20 can be used to access, create, update, delete, and store interaction data 27. The system 20 can be configured to trigger certain alerts and/or processing changes based on changes to interaction data 27. Thus, a change in interaction data 27 could automatically trigger a re-examination of a treatment plan by the provider 24 in certain circumstances. For example, interaction data 27 could indicate that a certain sequence of activities or combination of parameters may render a certain treatment ineffective or even undesirable.

4. Regimen data

Regimen data 29 is information relating to the treatment of conditions suffered by patients 22. Regimen data 29 can incorporate both information about the condition and the corresponding treatment. Regimen data 29 can be influenced by efficacy data 25, interaction data 27, and patient data 23 when it is applied to the context of developing a treatment (e.g. selecting a regimen) in the context of a particular patient 22 suffering a particular condition. In accessing regimen data 29, the system 20 can interface with, access, or incorporate diagnostic applications.

The system 20 can be used to access, create, update, delete, and store regiment data 29. The system 20 can be configured to trigger certain alerts and/or processing changes based on changes to regimen data 29. Thus, a change in regimen data 29 could automatically trigger a re-examination of a treatment plan by the provider 24 in certain circumstances.

III. High-Level Process Flow View

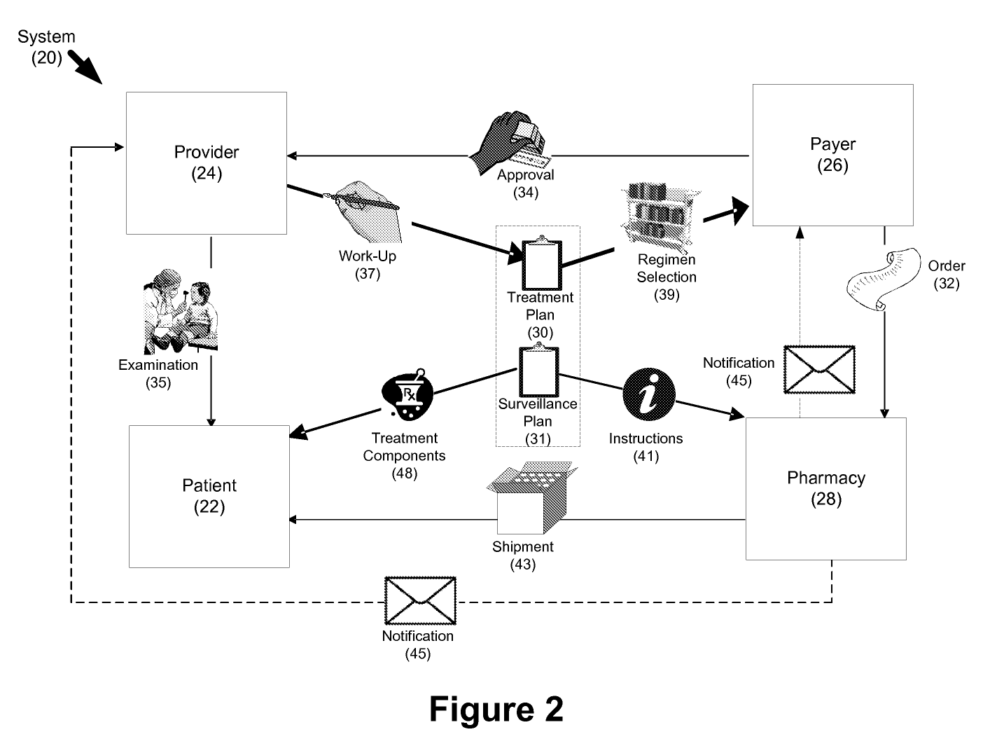

FIG. 2 is a process flow diagram illustrating some of the different processing elements that can be invoked as different entities interact with each other and the treatment plans and/or surveillance plans processed by the system 20.

Providers 24 can conduct an examination 35 of a patient 22, and store all of the data on the system 20. In conducting the examiner 35, the provider 24 can use the system 20 to access patient data 23, efficacy data 25, interaction data 27, and regimen data 29. Providers 24 can receive an approval 34 from payers 26 using the system 20. A draft treatment plan (e.g. a work-up 37) can be prepared by a provider 24 and submitted to the payer 26 using the system 20. Some embodiments of the system 20 will include automated approval processes, pre-approval processes, or even no approval process at all from the perspective of the payer 26. In many embodiments, the work-up 37 submitted by the provider 24 can include a regimen selection 39 from a library of regimens made accessible by the payer 26. As discussed above, the system 20 can be used to continuously update regimen data 29 for subsequent use by providers 24. Different embodiments of the system 20 can involve different rules with respect to options available to the provider 24 and different constraints imposed by payers 26. Some embodiments of the system 20 can include automated diagnostic tools which trigger template work-ups 37 as starting points for the provider 24 to use in creating the work-up 37.

Payers 26 can use the system 20 to transmit orders 32 to pharmacies 28, and approvals 34 to providers 24. Payers 26 can also use the system 20 to shape and influence the substance of treatment plans 30 and work-ups 37 created by providers 24. In many embodiments of the system 20, it will be the payer 26 who either operates the system 20 or pays for the entity who operates the system 20, such as an application service provider (“ASP”). The payer 26 can influence the processing performed by the system 20 by the approval process, whether automated or manual, by influencing the regimen selection 39, and by issuing orders 32 to the pharmacy 28.

The creation of an actionable treatment plan 30 (e.g. an approved treatment plan when the system 20 requires the treatment plan to be approved 30) triggers the submission of the order 32 and the creation of a surveillance plan 31 to monitor the impact of the treatment plan 30 on the condition of the patient 22. In some embodiments, the surveillance plan 31 is created and approved in a simultaneous or substantially simultaneous manner along with the treatment plan 30. In other embodiments of the system 20, the creation of the surveillance plan 31 occurs totally separately and distinctly from that of the treatment plan 30. Regardless of the origins of the surveillance plan 31, the submission of the order 32 to the pharmacy 28 can automatically trigger the system 20 to begin monitoring the treatment of the patient 22 in accordance with the surveillance plan 31.

Pharmacies 28 can use the system 20 to receive an instruction 41 originating from a treatment plan 30, an instruction originating from a surveillance plan 31, and/or orders 32 from payers 26. Pharmacies 28 can also use the system 20 to generate a shipment 43 to patients 22 and/or providers 24. By interfacing with pharmacies 28, the system 20 can better identify problems using the interaction data 27. Similarly, pharmacies 28 can utilize efficacy data 25, patient data 23, interaction data 27, and regimen data 29 in best implementing the instructions 41. Pharmacies 28 can initiate shipments 43 and notifications 45 to the appropriate entities, with the notifications 45 being sent in accordance with the pre-defined or dynamic rules of the system 20.

The system 20 can automatically gather, request, and store follow-up information in accordance with the surveillance plan 31. The surveillance plan 31 can be used not only to monitor the results of a treatment plan 30, but also to monitor the degree to which the patient 22 and/or other entities are complying with the treatment plan 30. For example, the system 20 can store surveillance data relating to the access of the patient 22 to a treating component 48, such as a pharmaceutical product, service by a third party, a medical device, or any other component of the treatment plan 30.

Different embodiments of the system 20 can be configured in a wide variety of different ways. The processing elements and steps identified in FIG. 2 are some examples of processing elements that can be incorporated in the functionality of the system 20. Some embodiments of the system 20 will not include all of the processing elements identified on FIG. 1. Similarly, many embodiments of the system 20 will include elements that are not displayed in FIG. 1.

IV. Technical Architecture

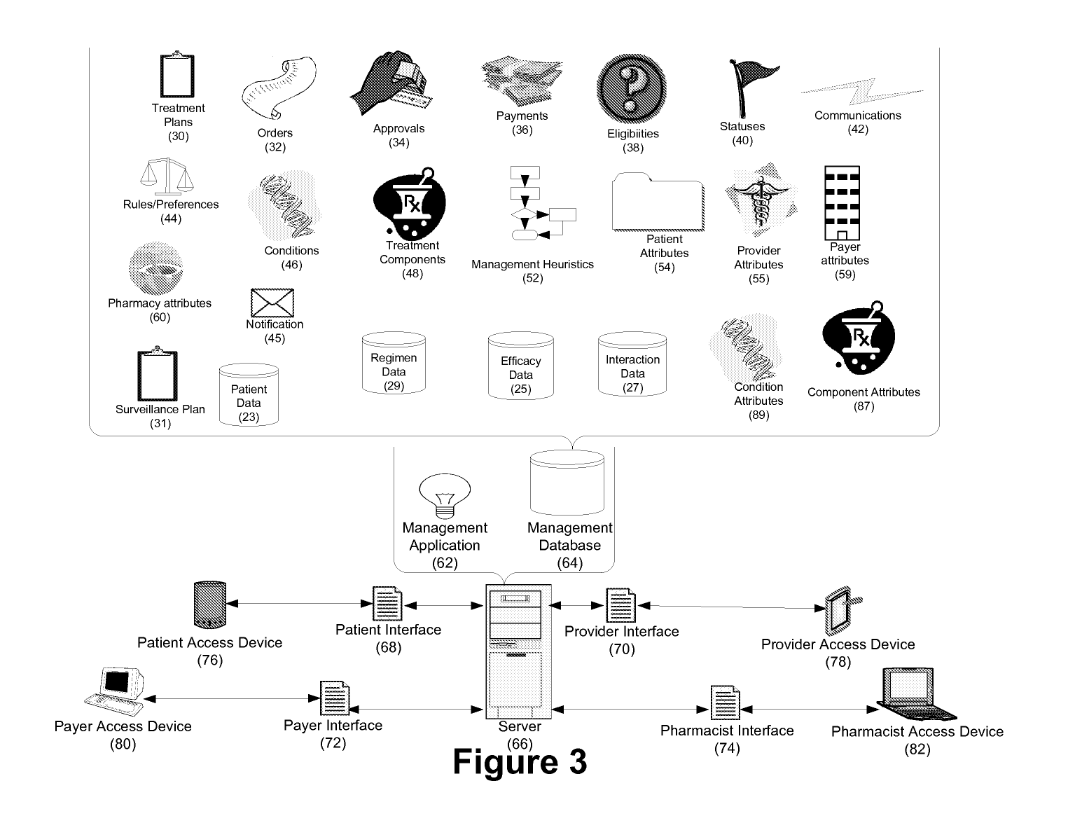

A wide range of different technical architectures and access devices can be used to implement and support the functionality of the system 20. The bottom portion of FIG. 3 is a block diagram illustrating an example of some of the different devices and interfaces that can be used by the system 20.

A management application 62 is one or more computer programs that are configured to implement one or more management heuristics 52 (described below). The application 62 can reside on one or more servers 62 that also house a management database 64. The data accessed and stored by the system 20 can reside on one or more management databases 64.

Different entities can interact with the system 20 with interfaces designed to support those interactions. In FIG. 3, the interfaces are web pages, but a wide variety of different interfaces could be used, including but not limited to GUI screens, voice recognition technology, etc. Similarly, a wide variety of access devices can be used to access the applicable interfaces.

In FIG. 3, a hand held computer is used as a patient access device 76 to access a patient interface 68. Other devices and interfaces could be used by patients 22 to access the system 20.

A desk-top computer is used as a payer access device 80 to access a payer interface 72. Other devices and interfaces could be used by payers 26 to access the system 20.

A tablet computer is used as a provider access device 78 to access a provider interface 78. Other devices and interfaces could be used by providers 24 to access the system 20.

A laptop computer is used as a pharmacy access device 82 to access a pharmacy interface 74. Other devices and interfaces could be used by pharmacies 28 to access the system 20.

The system 20 can customize the interactions of each entity accessing the system 20 in accordance with pre-defined and dynamic rules. The ability to access certain types of information, make certain types of decisions, trigger certain types of alerts, communications 42, notifications 45, etc.

V. Data elements

The top portion of FIG. 3 illustrates some examples of data elements that can be incorporated and used in the processing performed by the system 20.

1. Treatment Plans

As discussed above, a treatment plan 30 is a plan for treating a particular patient 22 with respect to a particular condition 46. Treatment plans 30 can include a variety of different treatment components 48 delivered over varying periods of time by a variety of different providers 24 and third-party suppliers. Many treatment plans 30 will include feedback-related courses of action so that the progress or lack of progress can be properly taken into consideration in the well being of the patient 22. Treatment plans 30 are typically tied to surveillance plans 31 to monitor patient compliance, the progress/success of the treatment plan 30, and to capture aggregated efficacy data 25.

The system 20 can support the creation, updating, implementation, management, and maintenance of pre-approved treatment plans 30. The system 20 can also support automated processing that allows numerous factors to selectively influence the creation, updating, implementation, management, and maintenance of treatment plans 30.

2. Orders

An order 32 is a request to purchase a good or service. In the context of treating a patient 22 in accordance with a treatment plan 30, orders typically involve various treatment components 48 such as pharmaceuticals, surgical procedures, lab tests, etc.

The system 20 can lower health care costs by bringing payers 26 into the “loop” at an earlier stage with respect to orders 32. Other entities such as pharmacies 28 can leverage prices negotiated by payers 26 for the particular order 32. Guided by efficacy data 50, payers 26 can use the system 20 to influence treatment plan 30 decisions made by providers 24.

3. Approvals

An approval 34 is a decision by a payer 26 to pay for a particular treatment component 48. In prior art methodologies, problems can arise because payers 26 are not brought into the decision-making process until after the work is performed and billed. Thus, providers 24 miss opportunities to take advantage of information and contractual relationships available to the payer 26 but not the provider 22. By front-loading payer 26 involvement using the system 20, many treatment components 48 can be pre-approved. The enhanced communications of the system 20 can also be used to approve items in a timely manner even though those items are not subject to free-standing pre-approvals.

4. Payments

The system 20 can be used by the various entities to submit bills and payments 36 to each other as appropriate. Billing and the sending of payments 36 can be automated using the system 20. A wide variety of payment technologies can be incorporated into the functionality of the system 20. The automated electronic processing of the system 20 can support the auto-adjudication of claims as well as automated payments.

5. Eligibilities

An eligibility 38 is a type of status 40 that identifies whether or not an entity is allowed to access a good or service. In many instances, eligibilities 38 relate to patients 22 in the context of particular treatment components 48. Payers 26 can use the eligibility 38 of a particular patient 22 to shape and/or influence decisions made by providers 24, pharmacies 28, and other third-party suppliers with respect to the patient 22.

The system 20 can be configured to automatically process and even automatically enforce the eligibility 38 of a particular patient 22 with respect to a particular treatment component 48 and a particular payer 26.

6. Statuses

The system 20 can be used to create, update, implement, and track a wide variety of different statuses 40. Statuses 40 can be associated with any entity. For example, a patient 22 in a particular stage of treatment can be associated with a particular type of status 40. Similarly, providers 24 involved in a particular area of specialty can be associated with a particular type of status 40. Statuses 40 can also be associated with the processing elements of the system 20, such as stages of a treatment plan 30, payments 36, approvals 34, orders 32, conditions 46, etc. Statuses 40 can be used to trigger events by the system 20 or otherwise influence the manner in which the system 20 performs its functionality. For example, if a particular therapy is not going well, that therapy could be associated with a particular status 40 that would either halt the therapy, or make the particular treatment plan 30 more likely to be re-reviewed by the provider 22 given the occurrence of other events or parameters.

7. Communications

The system 20 can be used to create, update, send, and receive a wide variety of communications 42 using a wide variety of different communication media. Standard communications 42 can be generated automatically using a template. The transmission of communications 42 can be triggered automatically, usually on the basis of a particular status 40 or change in status. The automated transmission of communications 42 can be controlled by various rules and/or preferences 44 defined within the system 20.

In addition to interacting through data transmitted or accessed using the system 20, the system 20 can generate automated, semi-automated (template communications), or manual communications between entities. For example, a pharmacy 28 may suggest a change to a provider 24 with respect to a particular treatment plan 30 or a provider 24 could communicate with a payer 26 to follow-up on a billing issue. Communications 42, unlike notifications 45, call for a response by the recipient.

8. Rules/Preferences

The system 20 uses rules 44 to constrain automated system processing and preferences 44 to influence or shape automated system processing. Different entities can be given the flexibility to submit their framework of rules 44 and preferences 44. The rules 44 and preferences 44 set by one entity (such as a payer 26) can influence the rules 44 and preferences 44 that can be set by another entity (such as a pharmacy 28). Different entities can interact with each other using the system 20 through the interactions of their various rules 44 and preferences 44. Rules 44 and preferences 44 can shape treatment plans 30.

Rules set by the payer 26 can be referred to as payer rules, rules set by the patient 22 can be referred to as patient rules, rules set by the pharmacy 28 can be referred to as pharmacy rules, and rules set by the provider 24 can be referred to as provider rules. The interaction of overlapping and/or even contradictory rules is governed by the system rules, which are typically set by the payer 26 or an ASP operating the system 20.

9. Conditions

A condition 46 is a disease (such as cancer), or some other medical malady or condition (collectively a “condition” 46). The treatment of a condition 46 with respect to a particular patient 22 is typically the focal point of a treatment plan 30.

The system 20 can be used to store data relating to conditions 46 on an ongoing basis in order to enhance the treatment plans 30 used to treat those conditions. The system 20 can be particularly beneficial with respect to conditions 46 that are chronic but nonetheless potentially very lethal, such as the different types of cancer. Different embodiments of the system 20 may focus on different types of conditions 46. Conditions 46 can be associated with various symptoms and other condition attributes 87 as discussed below.

10. Treatment Components

A treatment plan 30 can often involve multiple treatment components 48. A treatment component 48 is an individual line item of a treatment plan 30. For example, use of a particular pharmaceutical product could be one treatment component 48. Surgical procedures, pharmaceutical products, lab tests, and examinations by providers 24 are all examples of potential treatment components 48. Treatment plans 30 maintained on the system 20 can be used to automatically: schedule treatment components 48, track the implementation of treatment plans 30, and capture efficacy data 50.

11. Management Heuristics

The system 20 can use one or more treatment management heuristics 52 to create, select, update, improve, implement, and otherwise manage various treatment plans 30. The system 20 uses the heuristics 52 to make the processing decisions of the system 20. Different embodiments of the system 20 can incorporate widely different ranges of automated processing. Management heuristics 52 determine the degree to which various rules 44 can influence the processing of the system 20. For example, a variety of different heuristics can be used in an automated process for identifying and even prioritizing potential treatment components 48 for use in a treatment plan 30 of a particular condition 48. Similarly, different heuristics can govern the process for treatment plan approvals 34, orders 32, notifications 45, etc.

12. Patient attribute

A patient attribute 54 is any information that relates to the patient 22. Age, gender, family history, blood type, insurance policies, current medications, test results, x-ray images, and any information stored as patient data 23 can be a patient attribute 54 used by the system 20 to influence the processing of the system 20.

Any attribute relating to a patient 22 (e.g. patient attribute 54) can be a potentially important influence on a treatment plan 30. For example, a patient 22 could be allergic to a particular type of pharmaceutical product. In some embodiments of the system 20, patients 22 can be directly involved in the submission of their own patient attributes 54 to the system 20.

13. Provider Attribute

A provider attribute is any aspect or information that relates to the provider 24. Certifications, qualifications, quality assessment metrics, years of experience, areas of specialty, and potentially any other attribute associated with a provider 24 that can make a difference in the treatment of a patient 22 can be used by the system 20 to influence the processing of the system 20.

14. Payer Attribute

A payer attribute 59 is any attribute or information relating to the payer 26 that can be relevant to the selection and/or implementation of a treatment plan 30 and/or surveillance plan 31 of a patient 22. For example, if the payer 26 has an arrangement with a particular pharmaceutical supplier that is a payer attribute 59 that may influence which pharmaceutical option will be suggested to the provider 24 (subject to other concerns raised by efficacy data 25 and interaction data 27).

15. Pharmacy Attribute

A pharmacy attribute 59 is any attribute or information relating to the pharmacy 28 that can be relevant to the selection of a treatment plan 30 or surveillance plan 31.

16. Notification

A notification 45 is a one-way communication 42, e.g. a communication information one or more entities of the occurrence of some event or status 40. Notifications 45 can be triggered by rules 44 defined by the various entities. For example, if a provider 24 goes outside the boundaries of a preferred treatment option from the perspective of a payer 26, the system 20 can be configured to automatically notify the payer 26 so that it can communicate with provider 24 as to the provider's reasons for the decision.

17. Surveillance Plan

A surveillance plan 31 is the plan for monitoring compliance with the treatment plan 30 (e.g. was the appropriate medication given to the patient 22) and for monitoring the results/impact of the treatment (e.g. a monthly examination 35 to gather health data and determine whether or not the treatment plan 30 is working).

18. Patient Data

Patient data 23 includes all of the patient attributes 54 accessible to the system 20 in performing the functionality of the system 20. As discussed above, patient data 23 can be stored on the management database 64 or otherwise accessed using the management application 62 to assist providers 24 in creating work-ups 37 and plans 21.

19. Regimen Data

As discussed above, regimen data 29 can be stored on the management database 64 or otherwise accessed using the management application 62 to assist providers 24 in creating work-ups 37 and plans 21. As efficacy data 25 is accumulated, regimen data 29 can be added, updated, and/or deleted.

20. Efficacy Data

As discussed above, efficacy data 25 can be stored on the management database 64 or otherwise accessed using the management application 62 to assist in creating work-ups 37 and plans 21. The system 20 can generate efficacy data 25 for future use by monitoring the effectiveness of treatment plans 30 as they are implemented and modified. Thus, the outcome data generated by the system 20 with respect to a current patient can be automatically incorporated into the efficacy data 25 that is used to shape the processing for a future patient 22.

21. Interaction Data

As discussed above, interaction data 27 can be stored on the management database 64 or otherwise accessed using the management application 62 to assist in creating work-ups 37 and plans 21. The system 20 can generate interaction data 27 for future use by monitoring the effectiveness of treatment plans 30 as they are implemented and modified.

22. Condition Attribute

A condition attribute 89 is potentially any information relating to a condition 46, such as symptoms, causes, etc. that is stored on the database 64 or is otherwise accessible by the application 62.

23. Component Attribute

A component attribute 87 is potentially any information relating to a treatment component 48, such as dosage, chemical composition, applicable usage guidelines, etc. that is stored on the database 64 or is otherwise accessible by the application 62.

IV. Factors that can Influence a Treatment Plan

The rules 44 of the system 20 can be configured so that one or more data elements, individually or in combination, can impact the processing of the system 20. For example, high blood pressure alone may not trigger a change of status 40 or the sending of an alert or notification 45 by the system 20, but in conjunction with certain other patient attributes 54, provider attributes 55, payer attributes 59, pharmacy attributes 60, and patient data 23. regimen data 29, efficacy data 25, interaction data 27, or any other data element processed by the system 20 (many examples of which are disclosed in FIG. 3 and discussed above), communications 42 can be initiated, statuses 40 changed, notifications 45 sent, plans 21 amended, examinations 35 scheduled, etc.

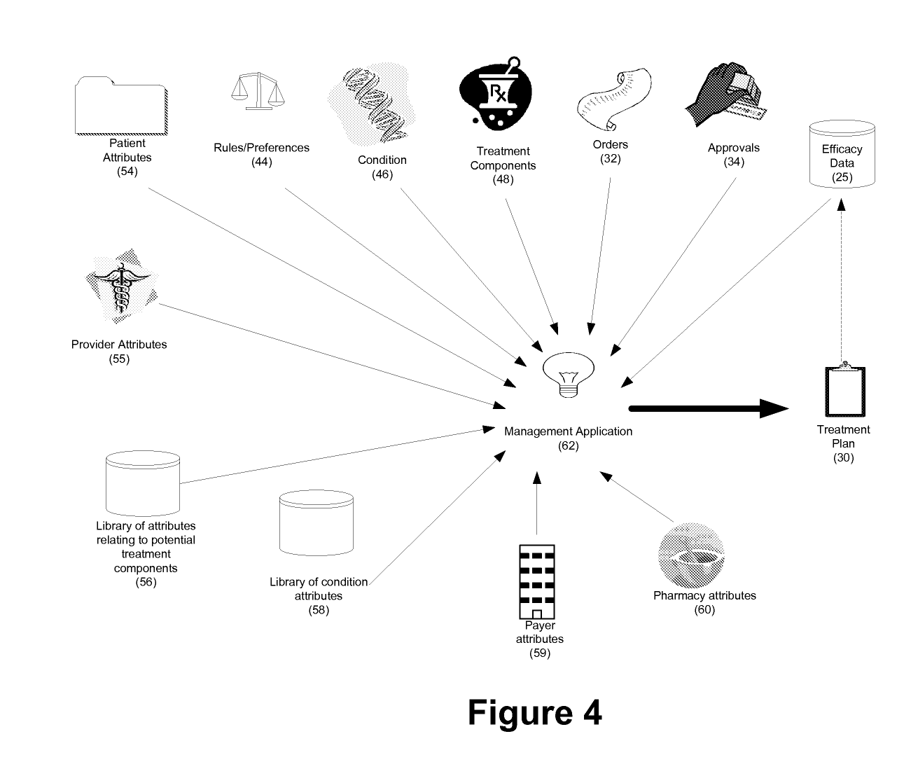

FIG. 4 is an input-output diagram illustrating an example of different processing elements that can influence a treatment plan 30. In some embodiments, a certain combination of one or more elements can have a mandatory or dispositive impact on a treatment plan 30. In other embodiments, the influences on the treatment plan 30 can be highly nuanced. The system 20 can be configured to weigh factors and combinations of factors in a highly sophisticated manner to effectuate the best interests of the patient 22.

As indicated in the Figure, the management application 62 can be influenced by a wide variety of different inputs that in turn influence the treatment plan 30, which in turn generates efficacy data which influences the processing performed by the management application 62.

A. Inputs

As illustrated in FIG. 4, there are a wide number of different processing elements and combinations of processing elements that can have an impact on a treatment plan 30. A discussed above, any of the data elements in FIG. 3 can constitute influential or even dispositive input with respect to a treatment plan 30 in a particular context.

Certain types of information are more likely to be influential on a repeated basis. Moreover, the system 20 can in certain embodiments be used to supported greater degrees of automated processing with respect to the diagnosis of a condition 48 and likely beneficial treatment components 48 corresponding to the diagnosed condition 48. Such data can be stored in such a way as to make the information easier to access as quickly as possible. FIG. 4 thus discloses a library of attributes relating to potential treatment components 56 and a library of condition attributes 58 as data that will often be indexed or otherwise stored in such a fashion as to facilitate quicker access to the information.

B. Management Application

As discussed above, the treatment management application 62 is a software application that houses the one or more treatment management heuristics 52 that determine the functionality of the system 20. Different embodiments of the application 62 will weight the different input factors differently. Feedback in the form of efficacy data 25 can influence the processing that is performed by the management application 62.

C. Output

The output generated in FIG. 2 is a treatment plan 30, although a similar diagram could be used to describe surveillance plans 31 and other functionality by the system 20. Many embodiments of the system 20 will incorporate numerous feedback loops so that information is constantly being updated in an effort to best serve the patient 22.

V. Subsystem-Level Views

A. Configuration 1

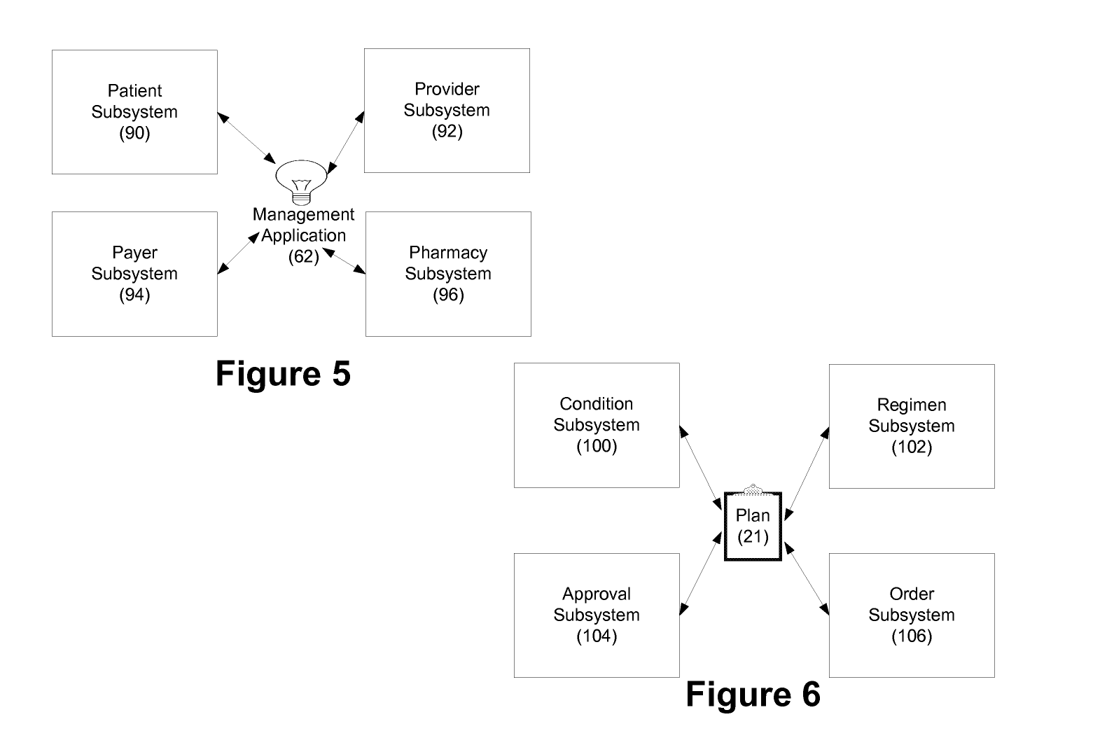

FIG. 5 is a block diagram illustrating an example of a subsystem-level view of the system 20. As displayed in FIG. 5, the management application 62 discussed above can serve as an interface for all of the subsystems in FIG. 5.

1. Patient Subsystem

All interactions between the patient 22 and the system 20 can be performed using a patient subsystem 90. The patient subsystem 90 can be used to provide information to the system 20 as well as to access information relevant to the patient 22.

2. Provider Subsystem

All interactions between the provider 24 and the system 20 can take place using a provider subsystem 92. The provider subsystem 92 in most embodiments of the system 20 houses the treatment management application 62 which is used to create treatment plans 30, subject to the influences of payers 26 and/or other entities as effectuated by the system 20.

3. Payer Subsystem

All interactions between the payer 26 and the system 20 can take place using a payer subsystem 94. The payer subsystem 94 is used to collect and disburse efficacy data 25 from other subsystems. The payer subsystem 94 can be used to create pre-approved treatment plans 30 and other guidelines for influencing treatment plans 30. The payer subsystem 94 can be used to shape the options available to the provider subsystem 92.

4. Pharmacy Subsystem

All interactions between the pharmacy 28 and the system 20 can take place using a pharmacy subsystem 96. Orders 32 and instructions 41 relating to a treatment plan 30 can be received using the pharmacy subsystem 96 and shipments 43 can be initiated by the pharmacy subsystem 28.

B. Configuration 2

FIG. 5 is a block diagram illustrating an example of a subsystem-level view of the system 20. As displayed in the Figure, a plan 21 can function as a nexus for communications and interactions between the various subsystems.

1. Condition Subsystem

A condition subsystem 100 can be used to store, access, and update information relating to medical conditions 44, such as cancer.

2. Regimen Subsystem

Treatment plans 30 can be created, updated, implemented, and selected using a regimen subsystem 102. The regimen subsystem 102 includes the treatment management application 62 discussed above,

3. Approval Subsystem

An approval subsystem 104 is used primarily by the payer 26 to approve treatment plans 30 and treatment components 48 proposed by providers 24.

4. Order Subsystem

An order subsystem 106 can be used to invoke automated processing triggered by approvals 34 generated by the approval subsystem 104. Many different entities can be involved in the process of fulfilling orders 32 generated by the system 20.

VI. Detailed Process Views

A. Payer Perspective

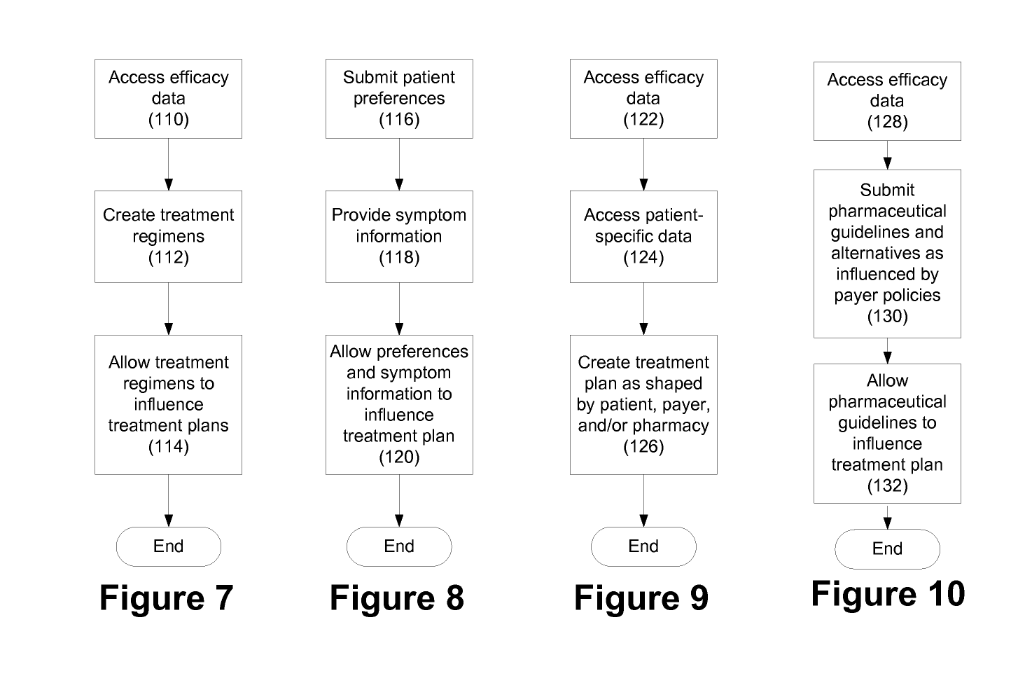

FIG. 7 is a process flow diagram illustrating an example of how a payer 26 can use the system 20 to influence treatment plans 30.

At 110, the payer 26 can access efficacy data 25 using the system 20.

At 112, treatment regimens (e.g. treatment plans 30) can be created by the payer 26 using the efficacy data 25 accessed at 110. In some embodiments, a library of pre-approved treatment plans 30 can be created at 112 by the payer 26.

At 114, the payer 26 relies on the system 20 to influence the treatment plans 30 created and/or selected by the provider 24. Different embodiments of the system 20 can provide providers 24 and payers 26 with different degrees of influence. In some embodiments, a provider 24 could be limited to selecting a pre-approved treatment plan 30. In other embodiments, the provider 24 is given a freer hand, although the payer 26 can still influence activities at 114 by rules/preferences 44 relating to treatment plans 30 at 112.

B. Patient Perspective

FIG. 8 is a process flow diagram illustrating an example of how a patient 22 can use the system 20 to influence their treatment plan 30.

Although not shown in FIG. 8, some embodiments of the system 20 may allow patients 22 to read articles and view certain data relating to their condition 46. Such data access activities could be performed at any point in the process.

At 116, the patient 22 can submit their preferences 44. In some embodiments, patients 22 can use the system 20 to provide detailed profiles including medical histories at 116.

At 118, the patient 22 can keep the system 20 updated with current symptom information 118. In some embodiments of the system 20, such updates can trigger automated updates to providers 24 and automated warnings to patients 22.

At 120, the system 20 uses the information supplied by the patient 22 to influence the treatment plan 30 relating to the patient 22. In many embodiments of the system 20, automated notifications to the provider 24 may result in additional provider-initiated communications 42 and activities.

C. Provider Perspective

FIG. 9 is a process flow diagram illustrating an example of a how a provider 24 can use the system 20 to create a treatment plan 30 for a patient 22.

At 122, the provider 24 can access the applicable efficacy data 50 stored on the system 20.

At 124, the provider 24 can access all applicable/relevant patient-specific data such as patient attributes 54.

At 126, the provider 24 can either select a pre-approved treatment plan 30 from a library of pre-approved treatment plans 30, or create a treatment plan 30 that is influenced or shaped to some degree by the payer 26 and/or patient 22.

D. Pharmacy Perspective

FIG. 10 is a process flow diagram illustrating an example of a pharmacy 28 using the system 20 to influence a treatment plan 30.

At 128, efficacy data 25 can be accessed.

At 130, guidelines and alternatives for a particular condition 46 can be submitted by the pharmacy 28.

At 132, the system 20 uses the pharmacy-provided data to influence and/or shape treatment plan 30 decisions by the provider 24.

E. System Perspective

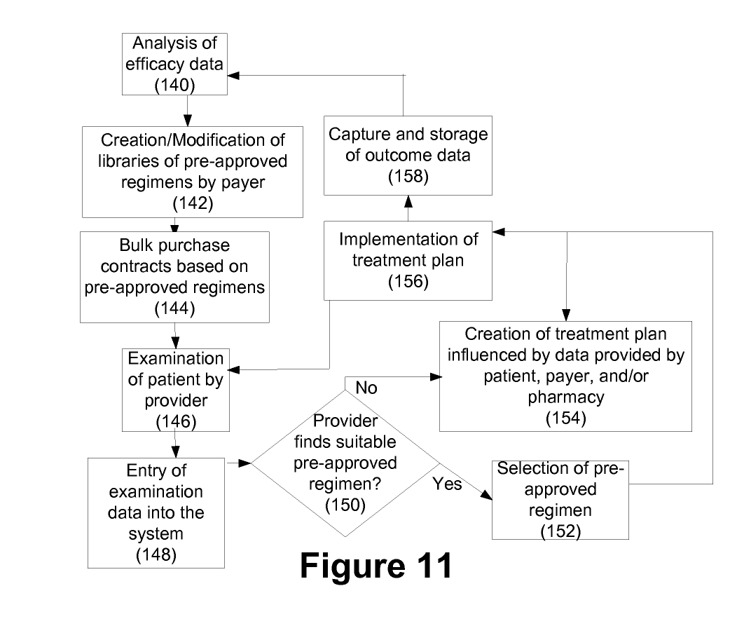

FIG. 11 is a multi-threaded process flow diagram illustrating an example of different entities using the system 20.

At 140, efficacy data 50 can be analyzed by various entities, including payers 26 and providers 24.

At 142, pre-approved libraries of treatment plans 30 and other forms of treatment guidelines are created by the payer 26.

At 144, contracting behavior such as bulk purchase agreements can be initiated based on the plans and guidelines created at 142.

The processing from 140 through 144 occurs without regards to a particular patient 22.

At 146, a patient 22 visits with a provider 24 is undergoes a medical examination.

At 148, relevant patient attributes 54 are entered into the system 20.

At 150, the provider 24 determines whether or not a pre-approved regimen (e.g. treatment plan 30) is appropriate. If so, a pre-approved treatment plan 30 is selected at 152. If not, a treatment plan 30 is created at 154 subject to the influences of the payer 26 as implemented by the system 20.

At 156, the treatment plan 30 is implemented.

After implementation of the treatment plan 30, the process becomes a multi-threaded process. Outcome data is captured and stored at 158 so that the database of efficacy data 50 at 140 can be updated for future patients 22. Subsequent examinations at 148 can lead to future revisions to the treatment plan 30 for the patient 22.

VII. Alternative Embodiments

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

1. A method of managing a treatment plan on a computer network, comprising:
making a database of efficacy data accessible to a provider interface;
receiving a work-up from the provider interface;
creating a treatment plan on the database from the work-up received from the provider interface;
assigning an approval status to the treatment plan;
sending an approval notice relating to the treatment plan to said provider interface and to a pharmacy interface, wherein the approval notice relates to the treatment plan;
invoking a surveillance plan to track and capture outcome information generated from the implementation of the treatment plan;
storing a plurality outcome information received from at least one of: (a) a payer interface; (b) the pharmacy interface; (c) the provider interface; and (d) a patient interface; and
automatically updating the efficacy data using the outcome information.

2. The method of claim 1, further comprising:
automatically changing the status of the treatment plan in response to the stored outcome information.

3. The method of claim 1, wherein the creation of the treatment plan is automatically influenced by an efficacy datum and a patient datum.

4. The method of claim 3, wherein the creation of the treatment plan is automatically influenced by a plurality of patient data, including business information, medical information, and surveillance information.

5. The method of claim 1, wherein the creation of the treatment plan is automatically influenced by a payer rule, a provider rule, a patient rule, and a pharmacy rule.

6. The method of claim 1, wherein the treatment plan relates to a condition of cancer, wherein the treatment plan includes a chemotherapy as a treatment component, and wherein the treatment plan is automatically modified before the completion of the treatment plan.

7. The method of claim 1, wherein the surveillance plan relates to a cancer condition, wherein the surveillance plan includes a pharmaceutical product, and wherein the surveillance plan is automatically modified before the completion of the surveillance plan.

8. The method of claim 1, wherein the work-up is selected from a pre-approved regimen selection.

9. The method of claim 1, further comprising an automatic sending of a notice to at least one of: (a) the payer interface; (b) the provider interface; (c) the patient interface; and (d) the pharmacy interface in response to a failure to comply with at least one of: (i) the treatment plan; and (ii) the surveillance plan.

10. The method of claim 1, wherein a surveillance plan is automatically created without human intervention after the approval of the treatment plan.

11. A healthcare management system, comprising:
an application and database residing on a server;
said database including a plurality of regimen data, a plurality efficacy data, a plurality of interaction data, a plurality of patient data, a treatment plan, and a surveillance plan;
said application providing for a patient interface, a provider interface, a payer interface, and a pharmacist interface;
wherein said treatment plan is selected from said provider interface and is selectively and automatically influenced by said patient data, and said efficacy data.

12. The system of claim 11, wherein said treatment plan selected from said provider interface is a pre-approved treatment plan.

13. The system of claim 11, wherein said surveillance plan is approved separate from the approval of said treatment plan.

14. The system of claim 11, wherein said efficacy data and said regimen data are updated before the completion of said surveillance plan.

15. The system of claim 11, wherein a status associated with said treatment plan is modified before the completion of said treatment plan.

16. The system of claim 11, said database further including a payer rule received thru said payer interface, wherein said payer rule influences said application to reject a work-up.

17. The system of claim 11, said application further providing for the capture of a plurality of outcome data, wherein receipt of said outcome data triggers a modification to said surveillance plan.

18. The system of claim 11, wherein the treatment plan relates to a condition of cancer, wherein the treatment plan includes a chemotherapy as a treatment component, and wherein the treatment plan is pre-approved from a regimen selection made with said provider interface.

19. The system of claim 11, wherein said efficacy data is automatically updated by said application.

20. A health care management system, comprising:
a provider subsystem, said provider subsystem providing for the scheduling of an examination with a patient, the creation of a work-up using a regimen selected using a provider interface, and the submission of the work-up for approval as a treatment plan, wherein the schedule of the examination, the work-up are stored on a database accessible by a payer subsystem;
said payer subsystem providing for populating a database with a plurality of regimen data and a plurality of efficacy data, wherein said payer subsystem further provided for approving a work-up as a treatment plan and transmitting an order corresponding to the treatment plan to a pharmacy subsystem;
said pharmacy subsystem providing for initiating at least one shipment and at least one notification;
wherein said treatment plan is associated with a surveillance plan, and wherein said system automatically collects a plurality of outcome data in accordance with said surveillance plan.
